(19) United States
(12) Patent Application Publication
(10) Pub. No.: US 2014/0198423 A1
(43) Pub. Date: Jul. 17, 2014

(54) CURRENT LIMITER CIRCUIT FOR CONTROL AND PROTECTION OF MOSFET

(71) Applicant: INNOREL SYSTEMS PRIVATE LIMITED, Bangalore (IN)

(72) Inventors: Sandeep Anand, Jaipur (IN); Rupak Ghayal, Bangalore (IN)

(73) Assignee: INNOREL SYSTEMS PRIVATE LIMITED, Bangalore (IN)

(21) Appl. No.: 14/154,509

(22) Filed: Jan. 14, 2014

(30) Foreign Application Priority Data
Jan. 15, 2013 (IN) 190/CHE/2013

(51) Int. Cl. H02H 9/02

(52) U.S. Cl. CPC H02H 9/02
USPC 361/93.9

(57) ABSTRACT

A circuit for controlling a Metal Oxide Semiconductor Field Effect Transistor (MOSFET) to generate a DC output voltage from a DC input voltage includes a first MOSFET and a second MOSFET. The circuit includes a gate resistor coupled to the first MOSFET. The circuit includes a first resistor and a zener diode coupled to the second MOSFET. In addition, the circuit includes a diode coupled to the zener diode and the first MOSFET. The circuit includes a first current path wherein the first current path includes the diode and the first MOSFET. The circuit includes a third MOSFET. Further, the circuit includes a Resistor-Capacitor (RC) filter coupled to source terminal of the third MOSFET. The circuit includes a third resistor having a first terminal and a second terminal, wherein the second terminal is coupled to drain terminal of the third MOSFET. The circuit also includes a fourth MOSFET.

### TECHNICAL FIELD

Embodiments of the disclosure relate generally to current limiting circuits, and more specifically, to a MOSFET based circuit for controlling and protecting the MOSFET.

### BACKGROUND

Semiconductor devices include a resistive current sensing circuit for limiting peak current. FIG. 1 illustrates a circuit 100 used in semiconductor devices for current sensing. The circuit 100 includes a sense resistor 105, a load 110, and an instrumentation amplifier 115. An input load current, I_{load} is converted to a voltage by the sense resistor 105 and a voltage V_{S} across the sense resistor 105 is amplified by the instrumentation amplifier 115. The voltage V_{S} is monitored by a protection circuit. Further, output of the instrumentation amplifier 115 is compared with a predefined voltage level. Due to the inherent self-inductance of the sense resistor 105 and the wiring inductances, the transient response of the circuit 100 becomes undesirable. Furthermore, it is not possible to measure a wide range of current without loss of accuracy in the circuit 100 because it requires large values of resistance which incurs additional power loss. In addition, the cost of the circuit 100 increases due to high precision amplifiers, for example the instrumentation amplifier 115.

In another prior art, a circuit generates a signal related to the current passed through a semiconductor device. The signal across the semiconductor device is monitored to limit peak current. FIG. 2 illustrates a circuit 200 used in Insulated Gate Bipolar Transistor (IGBT) devices for limiting the peak current. The circuit 200 includes a diode 205, a capacitor 210, an IGBT 215, and a load 220. The capacitor 210 senses a voltage V_{CE} across the IGBT 215. The voltage V_{CE} is given to a protection circuit to turn off the IGBT 215. Further, the diode 205 protects the circuit 200 by restricting high voltage of the main power circuit to appear on the circuit 200. The voltage drop across IGBT devices for a given current is similar. For example, for a rated current of 2 A, IGBT devices have a voltage 2.7V across it. The circuit 200 cannot employ Metal Oxide Semiconductor Field Effect Transistor (MOSFET) device in place of IGBT device as MOSFET devices have different voltage across it for the same peak current. For example, one MOSFET would give a voltage of 2.7V across it for 2 A current, whereas another MOSFET would give 2.7V for a 10 A current. It is desired to have a control and protection circuit for limiting peak current from the MOSFET and further generate a constant direct current (DC) voltage at the output of a DC-DC converter.

In light of the foregoing discussion, there exists a need for a current limiter circuit to maintain a fixed current across a MOSFET and further use this fixed current to generate a constant DC voltage at the output of a DC-DC converter.

### SUMMARY

The above-mentioned needs are met by a current limiter circuit for maintaining a fixed current across a Metal Oxide Semiconductor Field Effect Transistor (MOSFET) and further use this fixed current to generate a constant direct current (DC) voltage at the output of a DC-DC converter.

A circuit for controlling a MOSFET to generate a DC output voltage from a DC input voltage includes a first MOSFET having a gate terminal, a source terminal, and a drain terminal. The circuit includes a second MOSFET having a gate terminal, a source terminal, and a drain terminal, wherein the drain terminal of the second MOSFET is coupled to the gate terminal of the first MOSFET. The circuit includes a gate resistor having a first terminal and a second terminal, wherein the second terminal is coupled to the gate terminal of the first MOSFET. The circuit includes a first resistor having a first terminal and a second terminal, wherein the first terminal of the first resistor is connected to the second terminal of the gate resistor. The circuit includes a zener diode having a first terminal and a second terminal, wherein the second terminal is coupled to the gate terminal of the second MOSFET. The circuit includes a diode having a first terminal and a second terminal, wherein the first terminal of the diode is coupled to the first terminal of the zener diode, and the second terminal of the diode is connected to the drain terminal of the first MOSFET. The circuit includes a current path comprising the diode and the first MOSFET. The circuit includes a third MOSFET comprising a source terminal, a drain terminal, and a gate terminal, wherein a Resistor-Capacitor (RC) filter is coupled to the gate terminal of the third MOSFET. The circuit includes a third resistor having a first terminal and a second terminal, wherein the second terminal is coupled to the drain terminal of the third MOSFET. The circuit includes a fourth MOSFET having a source terminal, a gate terminal, and a drain terminal, wherein the gate terminal is coupled to the second terminal of the third resistor.

An example of a method of controlling MOSFET to generate a DC output voltage from a DC input voltage includes triggering a first MOSFET, in response to the DC input voltage. Further, the method includes reverse biasing a zener diode in response to increase in charging of a capacitor. Furthermore, the method includes triggering a second MOSFET in response to an increase in reverse bias voltage across the zener diode. The method includes limiting current across the first MOSFET from reaching a threshold by pulling the first MOSFET to logic LOW level, in response to a voltage division occurring between the second MOSFET and a gate resistor and thereby maintaining a fixed current across the first MOSFET. Further, the method includes generating the DC output voltage in a DC-DC converter from the fixed current delivered by the first MOSFET.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the disclosure, the disclosure is not limited to the examples depicted in the figures.

FIG. 1 illustrates a circuit with resistive current sensing for limiting peak current in semiconductor devices, in accordance with a prior art;

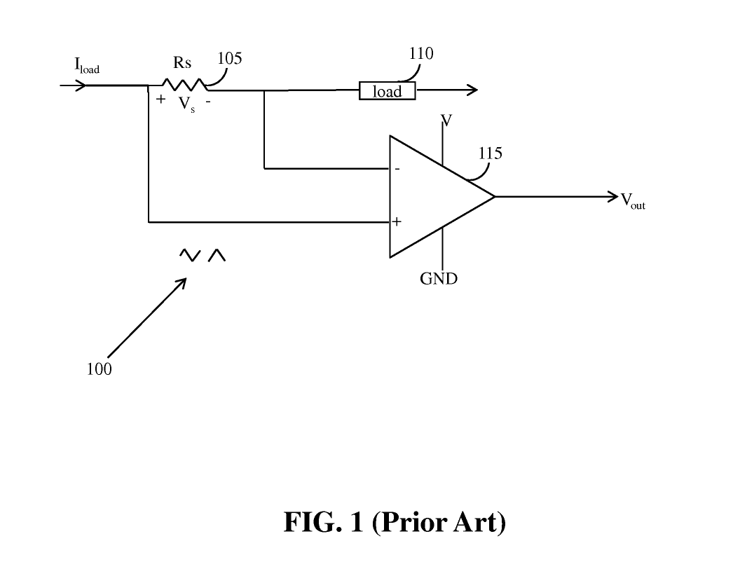

FIG. 2 illustrates a circuit for sensing voltage across an IGBT device, in accordance with another prior art;

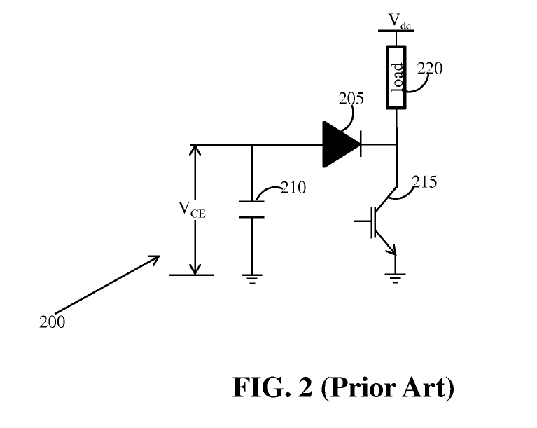

FIG. 3 is a circuit for controlling and protecting a MOSFET by limiting peak current, in accordance with one embodiment; and

FIG. 4 is a flow diagram illustrating a method of generating a DC voltage, in accordance with one embodiment.

### DETAILED DESCRIPTION OF THE EMBODIMENTS

A current limiter circuit for maintaining a fixed current across a MOSFET and further using this fixed current to generate a constant direct current (DC) voltage at the output of a DC-DC converter is explained in detail in the following description. The DC-DC convertor is an electronic circuit which converts a source of DC from one voltage level to another. Electronic Switch-mode DC-DC convertors convert one DC voltage to another, by storing the charge temporarily and then releasing that charge to the output at a different voltage. The storage can be in one of magnetic field storage components (inductors, transformers) and electric field storage components (capacitors). The flyback convertor is used in DC-DC conversion with galvanic isolation between the input and output.

In the present disclosure, relational terms such as first and second, and the like, can be used to distinguish one entity from the other, without necessarily implying any actual relationship or order between such entities.

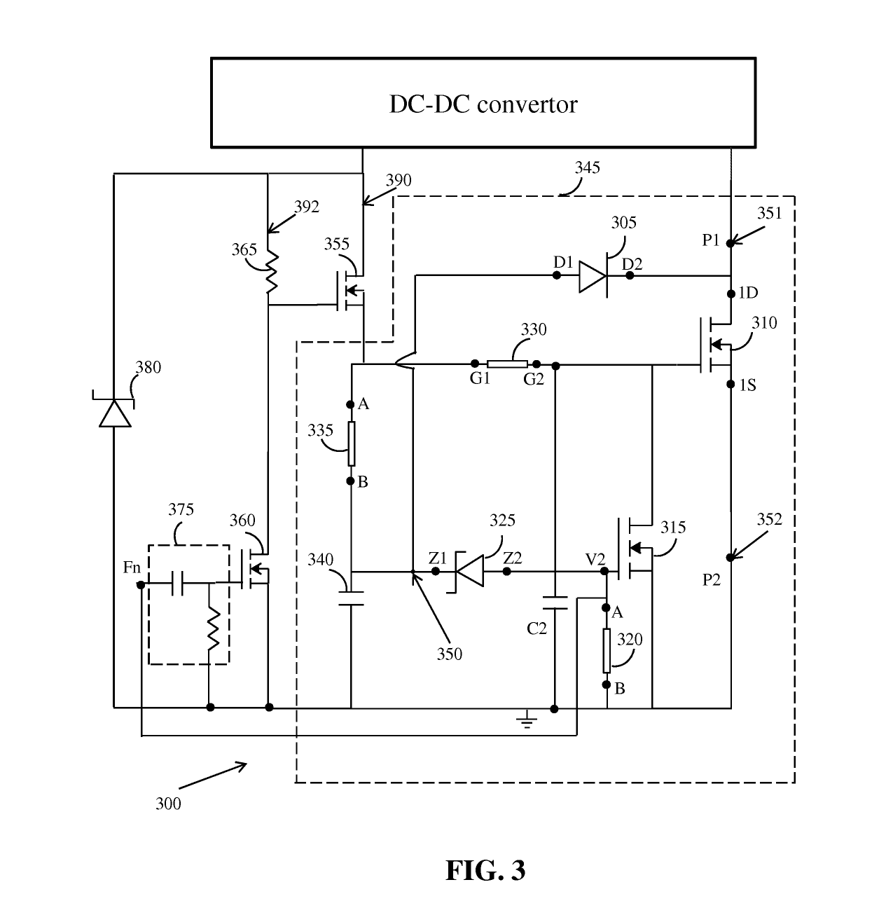

FIG. 3 illustrates a circuit 300, in accordance to one embodiment. The circuit includes a current limiting circuit 345 and a control circuit. The current limiting circuit 345, hereinafter referred to as protection circuit 345 protects a MOSFET 310 from overcurrent. The protection circuit 345 includes a first MOSFET 310 having a gate terminal, a source terminal, and a drain terminal. The protection circuit 345 includes a second MOSFET 315 having a gate terminal, a source terminal, and a drain terminal. The drain terminal of the second MOSFET 315 is coupled to the gate terminal of the first MOSFET 310. The protection circuit 345 further includes a gate resistor 330 hereinafter referred to as resistor 330 having a first terminal and a second terminal, wherein the second terminal is coupled to the gate terminal of the first MOSFET 310. Further, a first terminal A of a first resistor 335 is connected to the first terminal of the gate resistor 330.

The protection circuit 345 further includes a zener diode 325 having a first terminal Z1 and a second terminal Z2, wherein the second terminal Z2 is coupled to the gate terminal of the second MOSFET 315. The protection circuit 345 includes a diode 305 having a first terminal D1 and a second terminal D2, wherein the first terminal D1 is coupled to the first terminal Z1 of the zener diode 325, and the second terminal D2 is connected to the drain terminal of the first MOSFET 310. A current path includes the diode 305 and the first MOSFET 310. The protection circuit 345 further includes a capacitor 340 coupled to a second terminal B of the first resistor 335, a second resistor 320 having a first terminal A coupled to the second terminal Z2 of the zener diode 325 and the gate terminal of the second MOSFET 315. The source terminal of the first MOSFET 310, the source terminal of the second MOSFET 315, the second terminal B of the second resistor 320, and the second terminal of the capacitor 340 are coupled to a common ground. The protection circuit 345 further includes a capacitor C2 coupled to the second terminal of the gate resistor 330.

The control circuit includes a third MOSFET 360 having a source terminal, a drain terminal, and a gate terminal, wherein a Resistor-Capacitor (RC) filter 375 is coupled to the gate terminal of the third MOSFET 360. The control circuit further includes a third resistor 365 having a first terminal and a second terminal. The control circuit includes a fourth MOSFET 355 having a source terminal, a gate terminal, and a drain terminal, wherein the gate terminal is coupled to the second terminal of the third resistor 365, the source terminal of the fourth MOSFET 355 is coupled to the first resistor 335, and the drain terminal of the fourth MOSFET 355 is coupled to a DC-DC convertor. The control circuit includes a charging path 390 and charging path 392. The fourth MOSFET 355 is connected in the charging path 390 of the MOSFET 310. The second terminal of the third resistor 365 is coupled to the drain terminal of the third MOSFET 370. The control circuit further includes a feedback path from the gate terminal of the second MOSFET 315, wherein the feedback path includes the RC filter 375. The control circuit further includes a Zener diode 380.

In the protection circuit 345, the diode 305 in conjunction with the zener diode 325 limits peak current of the first MOSFET 310. Further, the second MOSFET 315 in conjunction with the gate resistor 330 pulls down the first MOSFET 310 to logic LOW level, wherein pulling down the first MOSFET 310 to logic LOW level protects the first MOSFET 310 from overcurrent.

In one embodiment, the first MOSFET 310 is an n-channel Metal Oxide Field Effect Transistor. A drain current I_{d} will flow through the MOSFET 310 when a positive gate voltage V_{GS} applied to the gate terminal is greater than a threshold voltage (V_{TH}). Increasing the positive gate voltage V_{GS} will cause channel resistance to decrease, causing an increase in the drain current I_{d}. In other words, the positive V_{GS} turns the MOSFET 310 “ON”, whereas a zero or negative V_{GS} turns the MOSFET 310 “OFF”.

The resistor 330 is used to control switching of the first MOSFET 310. The switching time, switching losses, reverse bias safe operating area, short-circuit safe operating area, and rate of increase of current of the first MOSFET 310 depends on value of the resistor 330. The current in the charging path 390 and the charging path 392 controls the triggering ON of the first MOSFET 310. The resistor 330 limits the magnitude of gate current during turning ON and turning OFF of the first MOSFET 310, thereby controlling the switching time. Moreover, during overcurrent condition, the resistor 330 ensures that gate of the MOSFET 310 is pulled to logic LOW level without interference to the DC input voltage in the charging path through the fourth MOSFET 355. The first MOSFET 310, the second MOSFET 315, the third MOSFET 360 and the fourth MOSFET 355 are one of n-channel MOSFET and p-channel MOSFET.

When a high voltage is supplied to the input, the fourth MOSFET 355 is pulled up and the MOSFET 355 starts conducting. As a result, the fourth MOSFET 355 supplies a low-voltage, for example, 10V to 15V, produced by the division of voltage across the Zener diode 380, the gate of the first MOSFET 310, and the resistor 330. Thereby, the first MOSFET 310 is turned ON. A part of drain current I_{d} starts to flows through the diode 305, the resistor 335, and MOSFET 355. A current path includes the diode 305, and the first MOSFET 310. Further, when the drain current I_{d} increases, voltage across point P1 351 and point P2 352 increases. The zener diode 325 is reverse biased when the voltage at node 350 exceeds the threshold level of the zener diode 325. Further, voltage at node V2 is pulled up by the reverse bias of the zener diode 325 and the second MOSFET 315 is turned ON. A voltage division occurs between the relatively high gate resistor 330 and the second MOSFET 315 which is having low ON Resistance. The voltage division pulls down the gate terminal of the MOSFET 310 to logic LOW state. Thereby, the MOSFET 310 is turned OFF. At this instant, the gate of the second MOSFET 315 is at logic HIGH state. A feedback is taken from node V₂ and applied across node Fₙ. Thus, the third MOSFET 360 is turned ON due to logic HIGH level of the second MOSFET 315.

Further, the fourth MOSFET 355 is pulled down to logic LOW level in response to the logic HIGH level of the third MOSFET 360. Therefore, there is no DC input supply to the protection circuit 345. Capacitor 340 discharges to ground through the resistor 335, the resistor 330 and the MOSFET 315. Therefore, the first MOSFET 310 is pulled down to logic LOW level. The second MOSFET 315 is pulled down to logic LOW in response to the discharge of the capacitor 340 and logic LOW level state of the fourth MOSFET 355. Further, the third MOSFET 360 is pulled to logic LOW level due to logic LOW level of the second MOSFET 315. Furthermore, the fourth MOSFET 355 is triggered in response to logic LOW level of the third MOSFET 360 which in turn turns ON the first MOSFET 310. This triggering OFF and triggering ON of the first MOSFET 310 keeps repeating in presence of peak current and thereby fixed current is delivered to the output of a DC-DC convertor to produce fixed DC voltage.

The rate at which peak current is reached in MOSFET 310 depends on the DC input voltage. However, when a Discontinuous Conduction Mode Flyback converter is used for DC-DC conversion, the current delivered to the output in one cycle remains constant. The frequency of switching also changes based on the input voltage, since during higher input voltage, the ON time of MOSFET 310 is lower, whereas the OFF time of MOSFET 310 is constant. This method is called variable frequency fixed peak current turn OFF method.

In the present disclosure, due to the feedback path from node V₂ to node F_{N}, the second MOSFET 315 and the third MOSFET 360 gets turned ON at the same time. The time for turning ON the second MOSFET 315 and the third MOSFET 360 is based on the values of the RC components in the RC filter 375. The voltage at node V₂, which is supplied by the resistor 335 and the capacitor 340, discharges completely after certain time. Therefore, first MOSFET 310 and second MOSFET 315 is turned to an OFF state. Thus, the circuit acts as an oscillating circuit with fixed peak voltage across first MOSFET 310 and oscillation time fixed by the various RC constants.

In one embodiment, the output of the control circuit is supplied to a flyback DC-DC convertor. In other embodiments the output is supplied to a non-isolated DC-DC convertor.

In one embodiment, the RC filter 375 can be one of a high pass filter and a low pass filter. In yet another embodiment, the feedback node Fₙ can be directly coupled to the third MOSFET 360.

The circuit 300 has the advantage that it provides pulse-by-pulse current protection. Additional current sensing components are not required, since peak current is limited by monitoring voltage drop across the first MOSFET 310. Further, the circuit 300 acts as a fixed peak controller for a fully controlled semiconductor switch, irrespective of the input voltage variation and the load variation.

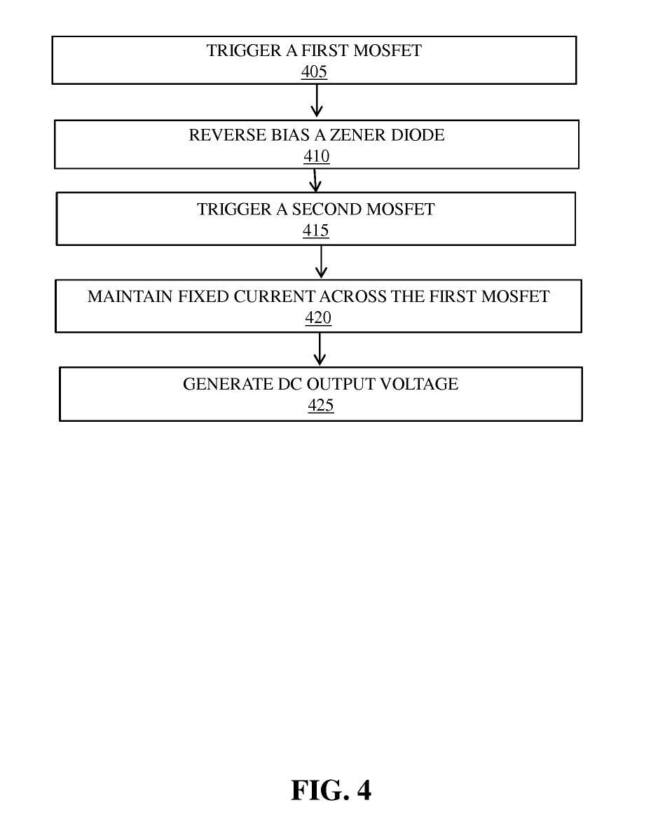

FIG. 4 is a flow diagram illustrating a method of generating a DC voltage.

At step 405, the first MOSFET 310 is triggered in response to a DC input supply. For example, an input voltage (10V-15V) is supplied across the gate of the first MOSFET 310, and then the MOSFET 310 goes to logic HIGH state. A current path includes the diode 305 and the first MOSFET 310.

At step 410, a zener diode 325 is reverse biased in response to the voltage at node 350. When the current from MOSFET 310 increases, voltage at node 351 increases. Thus, the voltage of node 350 increases. The zener diode 325 is reverse biased when the voltage at node 350 exceeds the threshold level of the zener diode 325.

At step 415, a second MOSFET 315 is triggered. The voltage at node V₂ is pulled up by the reverse bias of the zener diode 325 and the second MOSFET 315 is turned ON. A feedback is taken from node V₂ and applied across node Fₙ. Thus, the third MOSFET 360 is turned ON due to logic HIGH level of the second MOSFET 315.

At step 420, a fixed current is maintained across the first MOSFET 310. A voltage division occurs between a gate resistor 330 and the second MOSFET 315, due to logic HIGH level of the second MOSFET 315. The voltage division at point 311 pulls down gate of the MOSFET 310 to logic LOW state and thereby turns “OFF” the first MOSFET 310. Therefore, peak current of the first MOSFET 310 is controlled and fixed current is maintained across the first MOSFET 310.

At step 425, a DC output voltage is generated in a DC-DC converter from the fixed current delivered by the first MOSFET 310. The triggering OFF and triggering ON of the first MOSFET 310 keeps repeating in presence of peak current and thereby fixed current is delivered to the output of a DC-DC convertor to produce fixed DC voltage.

As will be understood by those familiar with the art, the disclosure may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the disclosure or its features may have different names, divisions and/or formats.

Accordingly, the disclosure of the present disclosure is intended to be illustrative, but not limiting, of the scope of the disclosure, which is set forth in the following claims.

What is claimed is:

1. A circuit for controlling a Metal Oxide Semiconductor Field Effect Transistor (MOSFET) to generate a direct current (DC) output voltage from a DC input voltage, the circuit comprising:
a first MOSFET having a gate terminal, a source terminal, and a drain terminal;
a second MOSFET having a gate terminal, a source terminal, and a drain terminal, wherein the drain terminal of the second MOSFET is coupled to the gate terminal of the first MOSFET;
a gate resistor having a first terminal and a second terminal, wherein the second terminal is coupled to the gate terminal of the first MOSFET;
a first resistor having a first terminal and a second terminal, wherein the first terminal of the first resistor is connected to the second terminal of the gate resistor;
a zener diode having a first terminal and a second terminal, wherein the second terminal is coupled to the gate terminal of the second MOSFET;
a diode having a first terminal and a second terminal, wherein the first terminal of the diode is coupled to the first terminal of the zener diode, and the second terminal of the diode is connected to the drain terminal of the first MOSFET;
a current path comprising the diode and the first MOSFET;
a third MOSFET comprising a source terminal, a drain terminal, and a gate terminal;
a Resistor-Capacitor (RC) filter coupled to the gate terminal of the third MOSFET;
a third resistor having a first terminal and a second terminal, wherein the second terminal is coupled to the drain terminal of the third MOSFET; and
a fourth MOSFET having a source terminal, a gate terminal, and a drain terminal, wherein the gate terminal is coupled to the second terminal of the third resistor.

2. The circuit as claimed in claim 1, wherein the diode in conjunction with the zener diode limits peak current of the first MOSFET.

3. The circuit as claimed in claim 1, wherein the second MOSFET in conjunction with the gate resistor pulls down the first MOSFET to logic LOW level, wherein pulling down the first MOSFET to logic LOW level protects the first MOSFET from overcurrent.

4. The circuit as claimed in claim 1 and further comprising:
a capacitor coupled to the second terminal of the first resistor.

5. The circuit as claimed in claim 1 and further comprising:
a second resistor having a first terminal coupled to the second terminal of the zener diode and the gate terminal of the second MOSFET.

6. The circuit as claimed in claim 1, wherein the source terminal of the first MOSFET, the source terminal of the second MOSFET, the second terminal of the second resistor, and the second terminal of the capacitor are coupled to a common ground.

7. The circuit as claimed in claim 1, wherein the first MOSFET, the second MOSFET, the third MOSFET, and the fourth MOSFET are one of an n-channel MOSFET and a p-channel MOSFET.

8. The circuit as claimed in claim 1, wherein the diode is a PN-junction diode.

9. The circuit as claimed in claim 1, wherein the source terminal of the fourth MOSFET is coupled to the first resistor, and the drain terminal of the fourth MOSFET is coupled to a DC-DC convertor.

10. The circuit as claimed in claim 1 and further comprising:
a feedback path from the source terminal of the second MOSFET, wherein the feedback path comprises the RC filter.

11. The circuit as claimed in claim 1, wherein the RC filter is one of a high pass filter and a low pass filter.

12. A method of controlling Metal Oxide Semiconductor Field Effect Transistor (MOSFET) to generate a direct current (DC) output voltage from a DC input voltage, the method comprising:
triggering a first MOSFET, in response to the DC input voltage;
reverse biasing a zener diode in response to increase in charging of a capacitor; triggering a second MOSFET in response to an increase in reverse bias voltage across the zener diode;
limiting the current across the first MOSFET from reaching a threshold by pulling the first MOSFET to logic LOW level, in response to a voltage division occurring between the second MOSFET and a gate resistor and thereby maintaining a fixed current across the first MOSFET; and
generating the DC output voltage in a DC-DC converter from the fixed current delivered by the first MOSFET.

13. The method as claimed in claim 12, wherein triggering the first MOSFET is based on logic HIGH level of a fourth MOSFET.

14. The method as claimed in claim 12, wherein the voltage division occurs in response to logic HIGH level of the second MOSFET.

15. The method as claimed in claim 12 and further comprising:
triggering the first MOSFET;
triggering a third MOSFET based on a first voltage at a feedback point, wherein the first voltage is caused due to logic HIGH level of the second MOSFET;
pulling down a fourth MOSFET to logic LOW level in response to the logic HIGH level of the third MOSFET;
turning the second MOSFET to logic LOW level in response to logic LOW level state of the fourth MOSFET;
turning the third MOSFET to a logic LOW level due to logic LOW level state of the second MOSFET; and
triggering the fourth MOSFET in response to the logic LOW level of the third MOSFET.

16. The method as claimed in claim 12, wherein controlling the current across the first MOSFET from reaching the threshold is based on the gate resistor.
